(19) United States
(12) Patent Application Publication
(10) Pub. No.: US 2025/0198754 A1
(43) Pub. Date: Jun. 19, 2025

(54) Leveling and Measuring Device

(71) Applicant: Todd Owen, Evergreen Park, IL (US)

(72) Inventor: Todd Owen, Evergreen Park, IL (US)

(21) Appl. No.: 18/950,821

(22) Filed: Nov. 18, 2024

Related U.S. Application Data
(60) Provisional application No. 63/612,043, filed on Dec. 19, 2023.

(51) Int. Cl. G01C 9/28; G01B 3/08

(52) U.S. Cl. CPC G01C 9/28; G01B 3/08

(57) ABSTRACT

A leveling and measuring device is provided comprised of a ruler, which may be constructed from various materials, such as transparent, semi-transparent, or opaque polymers, metals, or composites. The ruler includes measurement markings that can be printed, engraved, embossed, or laser-etched in metric or imperial units. A track is integrated or attached along the length of the ruler, allowing a cover to slide horizontally. The cover, made from similar materials as the ruler, features a level (bubble or digital) for proper alignment and a marking structure with a countersunk opening for guiding fasteners or drawing tools. The marking structure also includes indicia for precise alignment with the measurement markings. A locking mechanism, such as a friction lock, secures the cover in position along the track. The device may be used by positioning and securing the cover, aligning the marking structure with the desired measurement, and making precise markings on surfaces.

### CROSS-REFERENCE TO RELATED APPLICATION

The present application claims priority to, and the benefit of, U.S. Provisional Application No. 63/612,043, which was filed on Dec. 19, 2023, and is incorporated herein by reference in its entirety.

### FIELD OF THE INVENTION

The present invention relates generally to the field of measuring, marking, and leveling devices. More specifically, the present invention relates to a leveling and measuring device for making level, precisely spaced, and repeatable markings on a wall surface for hanging items. Accordingly, the present disclosure makes specific reference thereto. Nonetheless, it is to be appreciated that aspects of the present invention are also equally applicable to other like applications, devices, and methods of manufacture.

### BACKGROUND

Hanging items on a wall, such as picture frames, shelves, or artwork, can be a surprisingly complex and time-consuming process. This task often involves the use of several different tools to ensure that the items are placed accurately, both in terms of their height and alignment, to achieve a visually appealing result. Common tools required for this task include tape measures, spirit levels, pencils, and sometimes even laser levels. A tape measure is crucial for measuring distances, ensuring that items are placed at the right height or with equal spacing between multiple objects. Meanwhile, a level is used to ensure that the object is hung straight and does not tilt to one side, which can be especially important when hanging larger items or sets of frames where a slight misalignment can become more noticeable.

However, the need to use multiple tools simultaneously can be cumbersome and inconvenient for users, particularly if they are working alone. Balancing a tape measure and a level while trying to mark spots on the wall can be awkward, requiring multiple hands or repeated trips up and down a ladder. This issue is further compounded when working in spaces where moving around is restricted, such as narrow hallways or staircases. As a result, what might seem like a simple task of hanging an item on the wall often turns into a frustrating process involving constant repositioning, double-checking measurements, and adjusting for accuracy.

Moreover, even with these tools, it can be difficult to create perfectly level markings at precise distances on the wall surface before securing an item. Walls may have slight imperfections or uneven surfaces that make it harder to draw straight lines, and misjudgments of even a fraction of an inch can result in crooked results. These challenges can lead to unsightly gaps or uneven placements that detract from the overall aesthetic of a room. This not only diminishes the satisfaction of completing a task but may also necessitate starting over, further increasing the time and effort required.

Therefore, there exists a long-felt need in the art for a device that can be used to create markings for hanging items. There also exists a long-felt need in the art for a leveling and measuring device. More specifically, there exists a long-felt need in the art for a leveling and measuring device for creating level markings on a wall surface. In addition, there exists a long-felt need in the art for a leveling and measuring device for creating a level and equally and precisely spaced markings on a wall surface, wherein the markings can be easily transferred to various surfaces using the device.

The subject matter disclosed and claimed herein, in one embodiment thereof, comprises a leveling and measuring device. The device is comprised of a ruler, which may be constructed from various materials, such as transparent, semi-transparent, or opaque polymers, metals, or composites. The ruler includes measurement markings that can be printed, engraved, embossed, or laser-etched in metric or imperial units. A track is integrated or attached along the length of the ruler, allowing a cover to slide horizontally. The cover, made from similar materials as the ruler, features a level (bubble or digital) for proper alignment and a marking structure with a countersunk opening for guiding fasteners or drawing tools. The marking structure also includes indicia for precise alignment with the measurement markings. A locking mechanism, such as a friction lock, secures the cover in position along the track. The device may be used by positioning and securing the cover, aligning the marking structure with the desired measurement, and making precise markings on surfaces. The process can be repeated using additional covers to achieve consistent markings at desired intervals.

In this manner, the leveling and measuring device of the present invention accomplishes all the forgoing objectives and provides a device that can be used to create markings for hanging items. More specifically, the device can create level markings on a wall surface. In addition, the device can create precisely spaced markings on a wall surface, wherein the markings can be easily transferred to various surfaces using the device.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a leveling and measuring device. The device is comprised of a ruler, which may be made from materials such as transparent, semi-transparent, or opaque polymeric materials, metallic materials, or composites. Transparent options include acrylic, polycarbonate, or glass, while opaque options may use metals like aluminum or steel, or polymers like ABS or PVC. The ruler features at least one measurement marking, which may be in metric or imperial increments and can be printed, engraved, embossed, or laser-etched for durability and precision.

The ruler also includes at least one track, extending horizontally along its length, which can be a groove or slot formed integrally or an attached rail. This track is designed to guide at least one marking structure, part of a cover. The cover is slidably engaged with the ruler, allowing horizontal movement along the track. The cover may be constructed from similar materials as the ruler and includes at least one level, which can be a bubble or digital level for various orientations, aiding in alignment during use.

The marking structure includes a countersunk opening, permitting a fastener or writing utensil to be guided through for making a mark on a wall surface. The marking structure features at least one indicia, aligning with the measurement marking on the ruler, ensuring precise placement of the opening for accurate measurement transfer.

The position of the cover along the ruler can be secured using a locking mechanism, preferably a friction-lock mechanism. This may involve rotating or sliding a clamping element, or using a spring-loaded latch or threaded knob, to secure the cover in place.

A method of using the device involves providing the device with a ruler, measurement marking, and track, along with at least one cover with a body, level, marking structure, and locking mechanism. The cover is slid along the track to align an indicia with a desired measurement marking, and then locked in place. The user can make a marking through the hole while ensuring the device is level using the level. This process can be repeated with a second cover to create additional markings at equal or varying distances as needed.

Accordingly, the leveling and measuring device of the present invention is particularly advantageous as it provides a device that can be used to create markings for hanging items. More specifically, the device can create level markings on a wall surface. In addition, the device can create precisely spaced markings on a wall surface, wherein the markings can be easily transferred to various surfaces using the device. In this manner, the leveling and measuring device overcomes the limitations of existing methods and devices used to create markings while hanging items known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a leveling and measuring device of the present invention while collapsed in accordance with the disclosed architecture;

FIG. 2 illustrates a perspective view of one potential embodiment of a leveling and measuring device of the present invention while extended in accordance with the disclosed architecture; and

FIG. 3 illustrates a flowchart of a method of using one potential embodiment of a leveling and measuring device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to create markings for hanging items. There also exists a long-felt need in the art for a leveling and measuring device. More specifically, there exists a long-felt need in the art for a leveling and measuring device for creating level markings on a wall surface. In addition, there exists a long-felt need in the art for a leveling and measuring device for creating a level and equally and precisely spaced markings on a wall surface, wherein the markings can be easily transferred to various surfaces using the device.

The present invention, in one exemplary embodiment, is comprised of a leveling and measuring device. The device is comprised of a ruler, which can be made from materials such as transparent, semi-transparent, or opaque polymeric substances, metallic materials, or composites. Transparent materials include acrylic, polycarbonate, or glass, while opaque materials may include metals like aluminum or steel, or polymers such as ABS or PVC. The ruler has at least one measurement marking, which can be in metric or imperial units and may be printed, engraved, embossed, or laser-etched for enhanced durability and precision.

The ruler also includes at least one track running horizontally along its length, which can be a groove or slot formed integrally or an attached rail. This track is designed to guide at least one marking structure, part of a cover that can slide along the ruler. The cover is designed to move horizontally along the track and may be made from materials similar to those used for the ruler. It includes at least one level, which can be a bubble or digital level, to assist with alignment during use.

The marking structure features a countersunk opening, allowing a fastener or writing utensil to be inserted for making a mark on a wall surface. It also includes at least one indicia that aligns with the measurement markings on the ruler, ensuring accurate placement of the opening for precise measurement transfer.

The cover's position along the ruler can be fixed using a locking mechanism, preferably a friction-lock system. This might involve rotating or sliding a clamping element or using a spring-loaded latch or threaded knob to secure the cover.

To use the device, the user positions the ruler with its measurement markings and track, along with at least one cover containing a body, level, marking structure, and locking mechanism. The cover is moved along the track until an indicia aligns with a specific measurement marking, then locked in place. The user can then make a mark through the opening while keeping the device level. This process can be repeated with a second cover to create additional marks at equal or varying distances as required.

Thus, this leveling and measuring device offers a practical solution for creating marks when hanging items. Specifically, it enables users to create level markings on a wall and allows for the accurate transfer of precisely spaced markings to various surfaces. In doing so, the device addresses the limitations of existing tools and methods used for marking while hanging items.

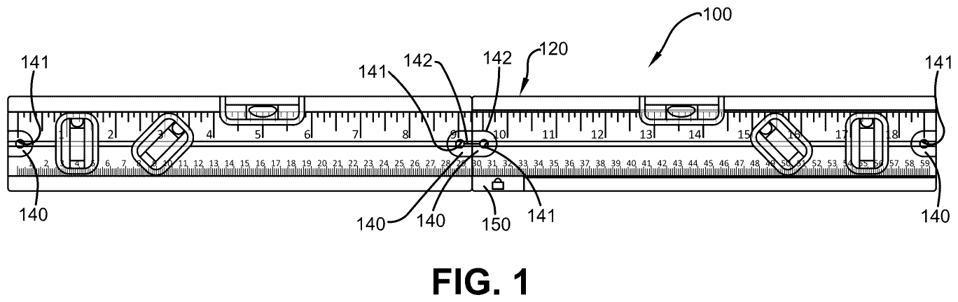

Referring initially to the drawings, FIG. 1 illustrates a perspective view of one potential embodiment of a leveling and measuring device 100 of the present invention while collapsed in accordance with the disclosed architecture. The device 100 is comprised of a ruler 110. The ruler 110 may be made from various materials, including but not limited to a transparent, semi-transparent, or opaque polymeric material, a metallic material, or a composite material. The transparent or semi-transparent options may include materials like acrylic, polycarbonate, or glass, while the opaque variants may be comprised of metals such as aluminum or steel, or opaque polymers like ABS or PVC. The ruler 110 is comprised of at least one opaque measurement marking 112. The measurement marking 112 may be in increments such as, but not limited to, millimeters, centimeters, inches, or any other imperial and/or metric measurement marking 112 known in the art. The measurement marking 112 may be printed, engraved, embossed, or laser-etched onto the ruler 110 to ensure durability and precision.

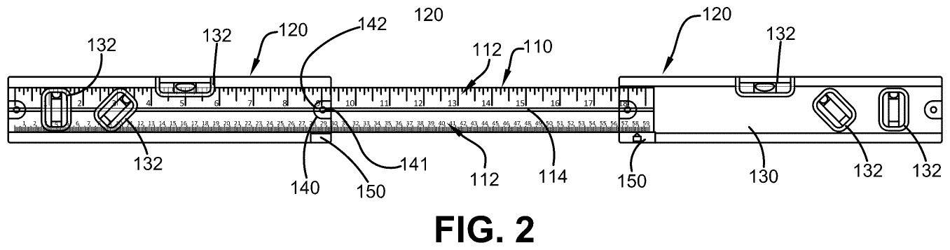

The ruler 110 is further comprised of at least one track 114 that extends horizontally along the length of the ruler 110. The track 114 may be a groove or slot formed integrally into the body of the ruler 110 or may be an attached rail. The track 114 is configured to receive and guide at least one marking structure 140 that is part of at least one cover 120. The cover 120 is slidably engaged with the ruler 110, allowing it to move horizontally along the length of the track 114, as seen in FIG. 2. The body 130 of the cover 120 may be manufactured from materials that include, but are not limited to, transparent, semi-transparent, or opaque polymeric or metallic materials, similar to those used for the ruler 110. The cover 120 is further comprised of at least one level 132. The level 132 may be, but is not limited to, a bubble level or a digital level. It can be configured for orientation in various directions, including vertical, horizontal, or diagonal, allowing the user to ensure the proper alignment of the device 100 during use.

The marking structure 140 is comprised of a countersunk opening 141 that allows a fastener, such as a screw or nail, to be driven through the opening 141 into a wall surface. Alternatively, the opening 141 may allow a user to guide a writing utensil, such as a pencil or pen, through the hole to draw a measurement mark onto a wall surface. The marking structure 140 may be comprised of at least one vertical and/or horizontal indicia 142 such as but not limited to a line, which may be printed, engraved, or molded onto the marking structure 140. The indicia 142 are designed to align precisely with the measurement marking 112 on the ruler 110, ensuring that the opening 141 is positioned correctly relative to the desired measurement. This alignment enables precise transfer of a mark or positioning of a fastener at a specific distance while referring to the marking 112.

In one embodiment, the position of the cover 120 along the ruler 110 may be fixed using at least one locking mechanism 150. The locking mechanism 150 may be any suitable type of mechanism but is preferably a friction-lock mechanism. This friction lock may be engaged or released by rotating or sliding a clamping element, allowing or restricting the movement of the cover 120 along the track 114 of the ruler 110. Alternatively, the locking mechanism 150 may be a spring-loaded latch or a threaded knob that, when tightened, presses against the ruler 110 to secure the cover 120 in a fixed position.

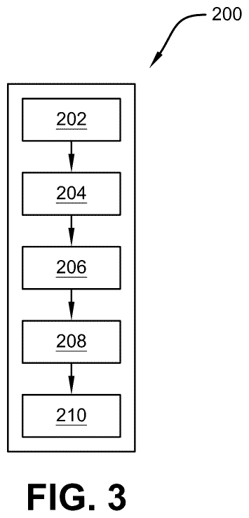

The present invention is also comprised of a method of using 200 the device 100, as seen in FIG. 3. First, a device 100 is provided, comprised of a ruler 110 that includes at least one measurement marking 112 and at least one track 114. The device 100 is further comprised of at least one (but preferably two) covers 120, each comprised of a body 130 with at least one level 132, at least one marking structure 140, and at least one locking mechanism 150 [Step 202]. Then, the cover 120 can be positioned at a desired length on the ruler 110 by sliding the cover 120 along the track 114, wherein an indicia 142 of the marking structure 140 can be aligned with a specific measurement marking 112 of the ruler 110, as seen in FIG. 2 [Step 204]. Then, the cover 120 can be secured in the desired position by engaging the locking mechanism 150 [Step 206]. Next, a user can utilize the device 100 to draw a marking through the hole 141 of the marking structure 140 onto a wall surface. During this process, the user may ensure that the device 100 is level by referencing the level 132 on the cover 120 [Step 208]. This process can be repeated with a second cover 120 of the device 100 to create a second marking at an equal or varying distance from the first marking, depending on the user's requirement [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “leveling and measuring device” and “device” are interchangeable and refer to the leveling and measuring device 100 of the present invention.

Notwithstanding the forgoing, the leveling and measuring device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the leveling and measuring device 100 as shown in the FIGS. are for illustrative purposes only, and that many other sizes and shapes of the leveling and measuring device 100 are well within the scope of the present disclosure. Although the dimensions of the leveling and measuring device 100 are important design parameters for user convenience, the leveling and measuring device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A leveling and measuring device comprising:
a ruler comprised of a measurement marking and a track extending horizontally along a length of the ruler;
a cover slidably engaged with the track of the ruler, the cover comprised of a body comprised of a level and a marking structure comprised of a countersunk opening and an indicia for alignment with the measurement marking; and
a locking mechanism configured to secure the cover in a fixed position along the track.

2. The leveling and measuring device of claim 1, wherein the measurement marking is comprised of a millimeter, a centimeter, or an inch.

3. The leveling and measuring device of claim 1, wherein the level is comprised of a bubble level.

4. The leveling and measuring device of claim 1, wherein the level is comprised of a digital level.

5. The leveling and measuring device of claim 1, wherein the level is comprised of a vertical level, a horizontal level, or a diagonal level.

6. The leveling and measuring device of claim 1, wherein the locking mechanism is comprised of a friction lock.

7. The leveling and measuring device of claim 1, wherein the cover is transparent.

8. A leveling and measuring device comprising:
a ruler comprised of a measurement marking and a groove or a rail;
a cover slidably engaged with the groove or the rail, the cover including a body comprised of a level;
a marking structure positioned on the cover with an opening and an indicia aligned with the measurement marking; and
a locking mechanism configured to restrict movement of the cover along the groove or the rail.

9. The leveling and measuring device of claim 8, wherein the indicia is comprised of a vertical line.

10. The leveling and measuring device of claim 8, wherein the indicia is comprised of a horizontal line.

11. The leveling and measuring device of claim 8, wherein the opening is comprised of a countersunk opening.

12. The leveling and measuring device of claim 8, wherein the locking mechanism is comprised of a spring-loaded latch.

13. The leveling and measuring device of claim 8, wherein the cover is transparent.

14. The leveling and measuring device of claim 8, wherein the ruler is transparent.

15. The leveling and measuring device of claim 8, wherein the measurement marking is comprised of an opaque measurement marking.

16. The leveling and measuring device of claim 8, wherein the marking structure engages the groove or the rail.

17. A method of using a leveling and measuring device, the method comprising the following steps:
providing a ruler comprised of measurement marking and a track, and a cover comprised of a body, a level, a marking structure having a countersunk opening, and a locking mechanism, wherein the cover is slidably engaged with the track;
positioning the cover along the ruler by sliding the cover along the track and aligning the marking structure with a specific measurement marking;
engaging the locking mechanism to secure the cover in a desired position; and
using the marking structure to draw a marking or position a fastener through the countersunk opening.

18. The method of using a leveling and measuring device of claim 17 further comprising a step of using the level on the cover to verify the orientation of the ruler before marking.

19. The method of using a leveling and measuring device of claim 17, wherein the cover is comprised of a transparent cover.

20. The method of using a leveling and measuring device of claim 17, wherein the marking structure is captured within the track.
